(19) United States
(12) Patent Application Publication
(10) Pub. No.: US 2018/0011828 A1
(43) Pub. Date: Jan. 11, 2018

(54) METHOD AND SYSTEM FOR RECOMMENDING MULTIMEDIA SEGMENTS IN MULTIMEDIA CONTENT FOR ANNOTATION

(71) Applicant: YEN4KEN, INC, PRINCETON, NJ (US)

(72) Inventors: Kuldeep Yadav, Gurgaon (IN); Kundan Shrivastava, Bangalore (IN); Sonal S. Patil, Dhule (IN); Om D. Deshmukh, Bangalore (IN); Nischal Murthy Piratla, Fremont, CA (US)

(21) Appl. No.: 15/205,050

(22) Filed: Jul. 8, 2016

(51) Int. Cl. G06F 17/24; G09B 5/06; G06F 3/0482

(52) U.S. Cl. CPC G06F 17/241; G06F 3/0482; G09B 5/065

(57) ABSTRACT

The disclosed embodiments illustrate methods for recommending multimedia segments in multimedia content associated with online educational courses for annotation via a user interface. The method includes extracting one or more features associated with the multimedia content, wherein a feature of the one or more features corresponds to at least a requirement of an exemplary instance. The method further includes selecting a set of multimedia segments from one or more multimedia segments in the multimedia content, based on historical data that corresponds to interaction of one or more users with the multimedia content and the extracted one or more features associated with the multimedia content. Further, the method includes recommending the selected set of multimedia segments in the multimedia content through the user interface displayed on the user-computing device associated with a user, wherein the user annotates the recommended set of multimedia segments in the multimedia content.

### TECHNICAL FIELD

The presently disclosed embodiments are related, in general, to multimedia content processing. More particularly, the presently disclosed embodiments are related to method and system for recommending multimedia segments in multimedia content for annotation.

### BACKGROUND

Advancements in the field of online education made Massive Open Online Courses (MOCCs) one of the popular modes of learning. Educational organizations provide various types of multimedia content, such as video lectures and/or audio lectures, to students for learning. Such multimedia content may contain one or more topics discussed over playback duration of the multimedia content.

Usually, the playback duration of such multimedia content (e.g., educational multimedia content) may be longer compared with the duration of non-educational multimedia content. In certain scenarios, it may be difficult for a user to understand the multimedia content due to various reasons, such as limited competency in presented language, little relevance of syllabus, fast speech rate, and the like. In such scenarios, a user may want to replace or annotate segment(s) of the multimedia content with more relevant and targeted content. However, the manual identification of such multimedia segments from the multimedia content is an arduous task. Thus, there is a requirement for an efficient mechanism to identify the multimedia segment(s) from the multimedia content for annotation.

Further limitations and disadvantages of conventional and traditional approaches will become apparent to those skilled in the art, through a comparison of described systems with some aspects of the present disclosure, as set forth in the remainder of the present application and with reference to the drawings.

### SUMMARY

According to embodiments illustrated herein, there is provided a method for recommending multimedia segments in multimedia content associated with online educational courses for annotation via a user interface. The method includes extracting, by one or more processors, one or more features associated with the multimedia content, wherein the multimedia content is selected, based on a user input received from a user-computing device, wherein a feature of the one or more features corresponds to at least a requirement of an exemplary instance. The method further includes selecting, by the one or more processors, a set of multimedia segments from one or more multimedia segments in the multimedia content, based on historical data that corresponds to interaction of one or more users with the multimedia content and the extracted one or more features associated with the multimedia content. The method further includes recommending, by the one or more processors, the selected set of multimedia segments in the multimedia content through the user interface displayed on the user-computing device associated with a user, wherein the user annotates the recommended set of multimedia segments in the multimedia content.

According to embodiments illustrated herein, there is provided a system for recommending multimedia segments in in multimedia content associated with online educational courses for annotation via a user interface. The system includes one or more processors configured to extract one or more features associated with the multimedia content, wherein the multimedia content is selected, based on a user input received from a user-computing device, wherein a feature of the one or more features corresponds to at least a requirement of an exemplary instance. The system further includes one or more processors configured to select a set of multimedia segments from one or more multimedia segments in the multimedia content, based on historical data that corresponds to interaction of one or more users with the multimedia content and the extracted one or more features associated with the multimedia content. The system further includes one or more processors configured to recommend the selected set of multimedia segments in the multimedia content through the user interface displayed on the user-computing device associated with a user, wherein the user annotates the recommended set of multimedia segments in the multimedia content.

According to embodiments illustrated herein, there is provided a computer program product for use with a computing device. The computer program product comprises a non-transitory computer readable medium storing a computer program code for recommending multimedia segments in multimedia content associated with online educational courses for annotation via a user interface. The computer program code is executable by one or more processors to extract one or more features associated with the multimedia content, wherein the multimedia content is selected, based on a user input received from a user-computing device, wherein a feature of the one or more features corresponds to at least a requirement of an exemplary instance. The computer program code is further executable by the one or more processors to select a set of multimedia segments from one or more multimedia segments in the multimedia content, based on historical data that corresponds to interaction of one or more users with the multimedia content and the extracted one or more features associated with the multimedia content. The computer program code is further executable by the one or more processors to recommend the selected set of multimedia segments in the multimedia content through the user interface displayed on the user-computing device associated with a user, wherein the user annotates the recommended set of multimedia segments in the multimedia content.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not to limit the scope in any manner, wherein similar designations denote similar elements, and in which:

FIG. 1 is a block diagram that illustrates a system environment in which various embodiments can be implemented, in accordance with at least one embodiment;

FIG. 2 is a block diagram that illustrates an application server, in accordance with at least one embodiment;

FIG. 3 is a flow diagram that illustrates a method to recommend multimedia segments, in multimedia content, to a user for annotation, in accordance with at least one embodiment;

FIG. 4 is a block diagram that illustrates an exemplary scenario for recommending multimedia segments, in multimedia content, to a user for annotation, in accordance with at least one embodiment; and

FIG. 5 illustrates an example Graphical user-interface (GUI) presented on a user-computing device to display recommended multimedia segments in multimedia content for annotation, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

Definitions: The following terms shall have, for the purposes of this application, the respective meanings set forth below.

“Multimedia content” refers to content that uses a combination of different content forms, such as text content, audio content, image content, animation content, video content, and/or interactive content. In an embodiment, the multimedia content may be a combination of a plurality of frames associated with multiple production styles. In an embodiment, the multimedia content may be reproduced on a user-computing device through an application, such as a media player (e.g., Windows Media Player®, Adobe® Flash Player, Microsoft Office®, Apple® QuickTime®, and the like). In an embodiment, the multimedia content may be downloaded from a server to the user-computing device. In an alternate embodiment, the multimedia content may be retrieved from a media storage device, such as Hard Disk Drive, CD Drive, Pen Drive, etc., connected to (or inbuilt within) the user-computing device.

A “frame” refers to a set of pixel data with information about an image that corresponds to a single picture or a still shot that is a part of multimedia content. Multimedia content is usually composed of a plurality of frames that are rendered in succession, on a display device, to present a seamless piece of the multimedia content. In an embodiment, each frame of the plurality of frames may be associated with a production style. Examples of the production style may include, but are not limited to, a “pdf” style, a PowerPoint (ppt) style, a classroom recording style, a digital tablet drawing style, and/or a talking instructor head style.

“One or more features” refer to one or more attributes associated with multimedia content. The one or more features may comprise requirement of an exemplary instance in the multimedia content, a speech rate associated with the multimedia content, timestamps associated with one or more concepts in the multimedia content, a style of frames in the multimedia content, and an occurrence of one or more graphical items in the multimedia content.

“One or more multimedia segments” refer to one or more sections of multimedia content that may be identified, based on one or more features associated with the multimedia content. In an embodiment, each of the one or more multimedia segments may be associated with two timestamps, such as a start-timestamp and an end-timestamp. In an embodiment, the duration of each of the one or more multimedia segments within the multimedia content may be less than the duration of the multimedia content.

“One or more aesthetic features” refer to features that are deterministic or representative of the look and feel of multimedia content in a frame from a plurality of frames. For instance, when the multimedia content corresponds to text content, the aesthetic features associated with the text may comprise, but not limited to, underline, highlight, bold, italics, a font size of the text, a color of the text, and a relative location of the text in a corresponding frame of the multimedia content. In another embodiment, when the multimedia content corresponds to an object/image, the aesthetic features associated with the object/image may comprise, but not limited to, a size of the object/image and a relative location of the object/image in a corresponding frame of the multimedia content.

A “pixel difference” may correspond to pixel values that are obtained when a subtraction between any two frames of a plurality of frames of multimedia content is performed. The pixel difference may indicate a degree of similarity between any two frames from the plurality of frames in the multimedia content. In an embodiment, if the pixel difference between the two frames of the multimedia content is below a pre-specified threshold, the two frames may be considered similar. Else the two frames are considered dissimilar. In an embodiment, the pixel difference may be utilized to identify one or more multimedia segments of the multimedia content.

An “exemplary instance” refers to a detailed explanation of a concept associated with multimedia content. In an embodiment, the requirement of an occurrence of the exemplary instance may be determined based on a prior interaction of one or more users with the multimedia content. For example, while viewing the multimedia content of duration, such as “40 minutes,” a user frequently uses pause-play operation between a time interval, such as “20:00 to 30:00,” of the multimedia content. In this scenario, the requirement of the exemplary instance may be determined between the time interval (i.e., “20:00 to 30:00”) of the multimedia content based on the prior interaction (i.e., the usage of pause-play operation) of the user with the multimedia content.

“Historical data” corresponds to data collected based on prior interaction of one or more users with multimedia content. In an embodiment, while viewing the multimedia content the one or more users might perform one or more operations, such as pause, play, stop, fast forward, navigation (to one or more websites), and/or the like, on the multimedia content. Further, the one or more operations of the one or more users may be recorded that may correspond to the historical data.

An “annotation” refers to an insertion of additional content in multimedia content. In an embodiment, the multimedia content may be annotated with the additional content, such as textual content, visual content, audio content, and/or external links to one or more websites. In an embodiment, the annotation of multimedia content may be based on one or more features extracted from the multimedia content.

A “concept” refers to a topic that is described over a duration of multimedia content. In an embodiment, the multimedia content may comprise one or more concepts.

A “diagram” refers to a graphical item in multimedia content. In an embodiment, the diagram may be illustrated for the description of a concept described in the multimedia content. For example, in multimedia content comprising a concept, such as the solar system, a diagram of the solar system may be illustrated. In an embodiment, the diagram in the multimedia content may be determined based on at-least one of a Mean-Shift Segmentation technique and/or a Sobel operator technique.

An “extraction” of one or more features involves an identification of one or the features that may be extracted from multimedia content. In an embodiment, the one or more features may comprise timestamps associated with one or more concepts in the multimedia content, a requirement of an exemplary instance, a speech rate associated with the multimedia content, a style of frames in the multimedia content and an occurrence of one or more graphical items in the multimedia content.

A “user-computing device” refers to a computer, a device including a processor/microcontroller and/or any other electronic component, device or system that performs one or more operations according to one or more programming instructions. Examples of the user-computing device include, but are not limited to, a desktop computer, a laptop, a personal digital assistant (PDA), a smartphone, or the like. The user-computing device is capable of accessing (or being accessed over) a network (e.g., using wired or wireless communication capability). In and embodiment, the user-computing device may be utilized for the transmission of an input received from a user. Further, the user-computing device may display an output, to the user, based on the received input.

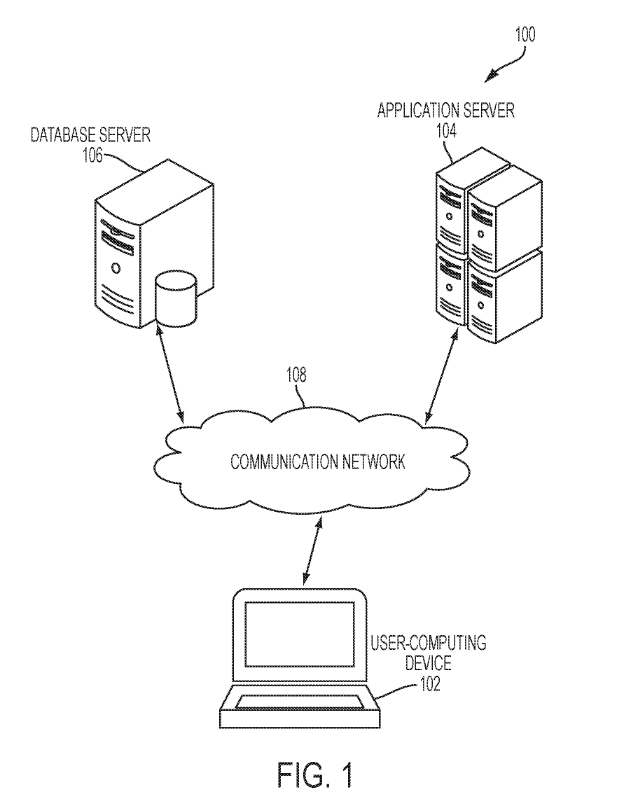

FIG. 1 is a block diagram of a system environment in which various embodiments can be implemented. With reference to FIG. 1, there is shown a system environment 100 that includes a user-computing device 102, an application server 104, a database server 106, and a communication network 108. Various devices in the system environment 100 may be interconnected over the communication network 108. FIG. 1 shows, for simplicity, one user-computing device, such as the user-computing device 102, one application server, such as the application server 104, and one database server, such as the database server 106. However, it will be apparent to a person having ordinary skill in the art that the disclosed embodiments may also be implemented using multiple user-computing devices, multiple application servers, and multiple databases, without departing from the scope of the disclosure.

The user-computing device 102 may refer to a computing device (associated with a user) that may be communicatively coupled to the communication network 108. The user-computing device 102 may include one or more processors and one or more memories. The one or more memories may include a computer readable code that may be executable by the one or more processors to perform one or more operations. In an embodiment, the user-computing device 102 may be configured to transmit an input, provided by the user for selecting the multimedia content, to the application server 104. In an embodiment, the user-computing device 102 may include hardware and/or software that may be configured to display the multimedia content to the user. In an embodiment, the user-computing device 102 may be further configured to display a user-interface, received from the application server 104, to the user. In an embodiment, the user-computing device 102 may be utilized by the user to annotate a recommended set of multimedia segments in the multimedia content, through the received user-interface.

A person having ordinary skill in the art will understand that the scope of the disclosure is not limited to the utilization of the user-computing device 102 by a single user. In an embodiment, the user-computing device 102 may be utilized by more than one users to provide the input.

The application server 104 refers to an electronic device computing device or a software framework hosting an application or a software service that may be communicatively coupled to the communication network 108. In an embodiment, the application server 104 may be implemented to execute procedures, such as, but not limited to, programs, routines, or scripts stored in one or more memories for supporting the hosted application or the software service. In an embodiment, the hosted application or the software service may be configured to perform one or more predetermined operations. In an embodiment, the one or more predetermined operations may include recommending the set of multimedia segments in the multimedia content, for annotation, to the user associated with the user-computing device 102.

In an embodiment, the application server 104 may be configured to select the multimedia content, based on the input received from the user-computing device 102. In an embodiment, the application server 104 may query the database server 106 for the retrieval of the selected multimedia content. In another embodiment, the application server 104 may receive the multimedia content from the user-computing device 102. In an embodiment, the application server 104 may be configured to extract one or more features from the multimedia content. In an embodiment, the one or more features may comprise the timestamps associated with one or more concepts in the multimedia content, a requirement of an exemplary instance, a speech rate associated with the multimedia content, a style of frames in the multimedia content and an occurrence of one or more graphical items in the multimedia content.

In an embodiment, the application server 104 may be further configured to determine one or more multimedia segments in the multimedia content. The application server 104 may utilize the extracted one or more features to determine the one or more multimedia segments. In an embodiment, the application server 104 may be further configured to select the set of multimedia segments from the one or more multimedia segments. In an embodiment, the application server 104 may select the set of multimedia segments based on historical data and the one or more features extracted from the multimedia content. Prior to the selection of the set of multimedia segments, the application server 104 may query the database server 106 to retrieve the historical data associated with the multimedia content. In an embodiment, the historical data may correspond to information pertaining to prior interaction of one or more users with the multimedia content.

In an embodiment, the application server 104 may be further configured to recommend the selected set of multimedia segments to the user associated with the user-computing device 102. In an embodiment, the application server 104 may recommend the selected set of multimedia segments through the user-interface that is displayed on the user-computing device 102.

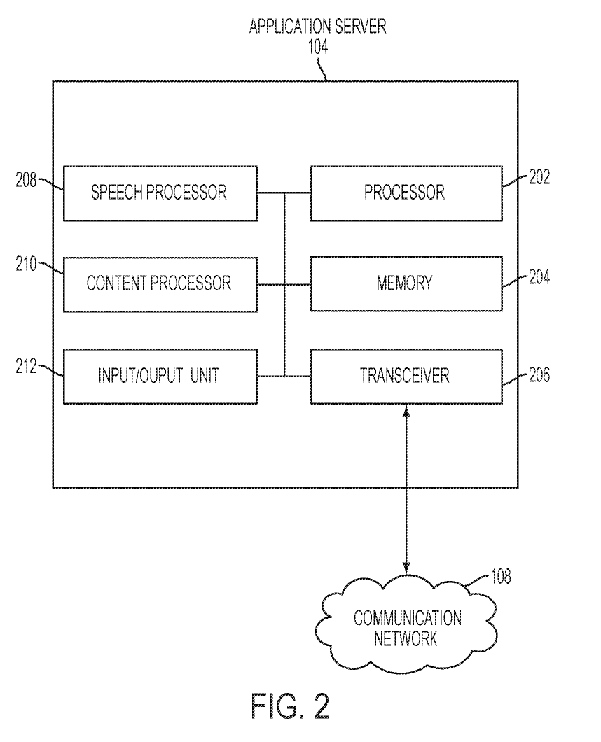

The application server 104 may be realized through various types of application servers such as, but not limited to, a Java application server, a .NET framework application server, a Base4 application server, a PHP framework application server, or any other application server framework. An embodiment of the structure of the application server 104 is described later in FIG. 2.

A person having ordinary skill in the art will appreciate that the scope of the disclosure is not limited to realizing the application server 104 and the user-computing device 102 as separate entities. In an embodiment, the application server 104 may be realized as an application program installed on and/or running on the user-computing device 102, without departing from the scope of the disclosure.

The database server 106 may refer to a computing device that may be communicatively coupled to the communication network 108. In an embodiment, the database server 106 may be configured to store the multimedia content and the historical data. In an embodiment, the database server 106 may be configured to receive the multimedia content from one or more websites. In an embodiment, the historical data may correspond to the information pertaining to the prior interaction of the one or more users with the multimedia content. In an embodiment, the prior interaction may include a use of one or more operations, such as pause, fast forward, and stop, while viewing the multimedia content. In another embodiment, the prior interaction may include navigation to one or more websites, while viewing the multimedia content. In an embodiment, the user may record the prior interaction of the one or more users with the multimedia content, when the one or more users were viewing the multimedia content. The user may further process the recorded interaction for determining the historical data by utilizing one or more web analytics tools known in the art. Thereafter, the historical data associated with the multimedia content may be stored in the database server 106. In another embodiment, the user may extract the historical data associated with the multimedia content from one or more user analytics databases (not shown).

In an embodiment, the database server 106 may be configured to receive the query for the retrieval of the multimedia content and the historical data from the application server 104. Thereafter, the database server 106 may be configured to transmit the multimedia content and the historical data to the application server 104 based on the received query. For querying the database server 106, one or more querying languages may be utilized, such as, but not limited to, SQL, QUEL, and DMX.

In an embodiment, the database server 106 may be configured to store a user profile of the user that may be created during the registration of the user. The user profile of the user may comprise information pertaining the identification of the user and demographic details, such as age, gender, language, and/or the like, of the user.

In an embodiment, the database server 106 may be realized through various technologies, such as, but not limited to, Microsoft® SQL Server, Oracle®, IBM DB2®, Microsoft Access®, PostgreSQL®, MySQL® and SQLite®.

A person having ordinary skill in the art will appreciate that the scope of the disclosure is not limited to realizing the database server 106 and the application server 104 as separate entities. In an embodiment, the functionalities of the database server 106 can be integrated into the application server 104, without departing from the scope of the disclosure.

In an embodiment, the communication network 108 may correspond to a communication medium through which the application server 104, the database server 106, and the user-computing device 102 may communicate with each other. Such a communication may be performed, in accordance with various wired and wireless communication protocols. Examples of such wired and wireless communication protocols may include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, 2G, 3G, 4G cellular communication protocols, and/or Bluetooth (BT) communication protocols. The communication network 108 may include, but is not limited to, the Internet, a cloud network, a Wireless Fidelity (Wi-Fi) network, a Wireless Local Area Network (WLAN), a Local Area Network (LAN), Long-Term Evolution (LTE), a telephone line (POTS), and/or a Metropolitan Area Network (MAN).

FIG. 2 is a block diagram that illustrates an application server, in accordance with at least one embodiment. FIG. 2 has been described in conjunction with FIG. 1. With reference to FIG.2, there is shown the application server 104 that may include a processor 202, a memory 204, a transceiver 206, a speech processor 208, a content processor 210, and an input/output unit 212. The processor 202 is communicatively coupled to the memory 204, the transceiver 206, the speech processor 208, the content processor 210, and the input/output unit 212.

The processor 202 includes suitable logic, circuitry, and/or interfaces that are operable to execute one or more instructions stored in the memory 204. The processor 202 may further comprise an arithmetic logic unit (ALU) (not shown) and a control unit (not shown). The ALU may be coupled to the control unit. The ALU may be configured to perform one or more mathematical and logical operations and the control unit may control the operation of the ALU. The processor 202 may execute a set of instructions/programs/codes/scripts stored in the memory 204 to perform the one or more predetermined operations. In an embodiment, the one or more predetermined operations may include recommending the set of multimedia segments in the multimedia content to the user associated with the user-computing device 102. The processor 202 may be implemented using one or more processor technologies known in the art. Examples of the processor 202 may include, but are not limited to, an x86 processor, an ARM processor, a Reduced Instruction Set Computing (RISC) processor, an Application Specific Integrated Circuit (ASIC) processor, a Complex Instruction Set Computing (CISC) processor, or any other processor.

The memory 204 may be operable to store one or more machine codes, and/or computer programs having at least one code section executable by the processor 202. The memory 204 may store the one or more sets of instructions that are executable by the processor 202, the transceiver 206, the speech processor 208, the content processor 210, and the input/output unit 212. In an embodiment, the memory 204 may include the one or more machine codes, and/or computer programs that are executable by the processor 202 to perform the one or more predetermined operations. In an embodiment, the memory 204 may include one or more buffers (not shown). The one or more buffers may store the one or more features extracted from the multimedia content. The one or more buffers may further store information pertaining to the one or more multimedia segments of the multimedia content. Some of the commonly known memory implementations may include, but are not limited to, a random access memory (RAM), a read only memory (ROM), a hard disk drive (HDD), and a secure digital (SD) card.

The transceiver 206 transmits/receives messages and data to/from various components, such as the user-computing device 102, the application server 104, and the database server 106 of the system environment 100, over the communication network 108. In an embodiment, the transceiver 206 may be communicatively coupled to the communication network 108. In an embodiment, the transceiver 206 may be configured to receive the multimedia content from the database server 106. Further, the transceiver 206 may be configured to transmit the user interface to the user-computing device 102, through which the multimedia content is rendered on the user-computing device 102. Examples of the transceiver 206 may include, but are not limited to, an antenna, an Ethernet port, a USB port, or any other port configured to receive and transmit data. The transceiver 206 transmits/receives the messages and data, in accordance with the various communication protocols, such as TCP/IP, UDP, and 2G, 3G, or 4G communication protocols.

The speech processor 208 includes suitable logic, circuitry, and/or interfaces that may be configured to execute the one or more sets of instructions stored in the memory 204. In an embodiment, the speech processor 208 may be configured to determine the speech rate of the audio content of the multimedia content. In an embodiment, the speech processor 208 may utilize one or more speech processing techniques known in the art for the determination of the speech rate of the audio content of the multimedia content. Examples of the one or more speech processing techniques may include, but are not limited to, Automatic Speech Recognition (ASR) technique voice activity detection (VAD) technique, and phonetically motivated technique. The speech processor 208 may be implemented based on a number of processor technologies known in the art. Examples of the speech processor 208 may include, but are not limited to, a word processor, an X86-based processor, a RISC processor, an ASIC processor, and/or a CISC processor.

The content processor 210 includes suitable logic, circuitry, and/or interfaces that may be configured to execute the one or more sets of instructions stored in the memory 204. In an embodiment, the content processor 210 may be configured to identify the one or more concepts associated with the multimedia content. In an embodiment, the content processor 210 may utilize one or more concept detection algorithms, known in the art, for the identification of the one or more concepts associated with the multimedia content. Examples of the one or more concept detection algorithms may include, but are not limited to, scale-invariant feature transform (SIFT) technique and optical character recognition (OCR) technique. In an embodiment, the content processor 210 may be further configured to identify a requirement of the exemplary instance in the identified one or more concepts. In an embodiment, the content processor 210 may be further configured to determine the style of frames in the multimedia content, the timestamps associated with the one or more concepts in the multimedia content, and the occurrence of one or more graphical items in the multimedia content. The content processor 210 may be implemented based on a number of processor technologies known in the art. Examples of the content processor 210 may include, but are not limited to, a word processor, an X86-based processor, a RISC processor, an ASIC processor, and/or a CISC processor.

The input/output unit 212 comprises suitable logic, circuitry, interfaces, and/or code that may be configured to receive an input or transmit an output to the user-computing device 102. The input/output unit 212 comprises various input and output devices that are configured to communicate with the processor 202. Examples of the input devices include, but are not limited to, a keyboard, a mouse, a joystick, a touch screen, a microphone, a camera, and/or a docking station. Examples of the output devices include, but are not limited to, a display screen and/or a speaker.

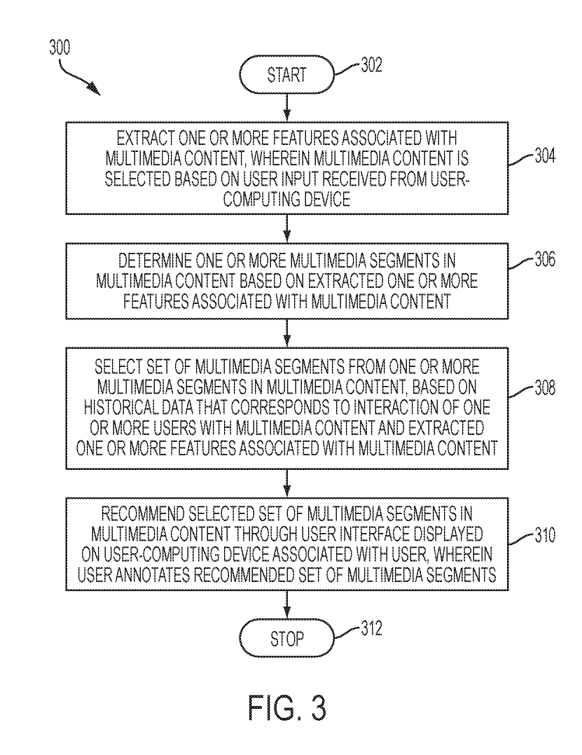

An embodiment of a method for recommending the set of multimedia segments, in the multimedia content, for annotation has been described later in FIG. 3.

FIG. 3 depicts a flowchart that illustrates a method to recommend multimedia segments, in the multimedia content, to a user for annotation, in accordance with at least one embodiment. FIG. 3 is described in conjunction with FIG. 1 and FIG. 2. With reference to FIG. 3, there is shown a flowchart 300 that illustrates the method to recommend multimedia segments, in the multimedia content, to a user for annotation. The method starts at step 302 and proceeds to step 304.

At step 304, the one or more features associated with the multimedia content are extracted. In an embodiment, the content processor 210, in conjunction with the processor 202, may be configured to extract the one or more features associated with the multimedia content. In an embodiment, the one or more features may comprise the speech rate associated with the multimedia content, the style of frames in the multimedia content, the timestamps associated with the one or more concepts in the multimedia content, the requirement of the exemplary instance, and the occurrence of one or more graphical items in the multimedia content.

In an embodiment, prior to the extraction of the one or more features, the processor 202 may be configured to select the multimedia content. In an embodiment, the application server 104 may select the multimedia content, based on the input received from the user associated with the user-computing device 102. Thereafter, the processor 202 may be configured to query the database server 106 for retrieving the selected multimedia content, via the transceiver 206. In an alternate embodiment, the processor 202 may receive the multimedia content transmitted by the user (i.e., the user input), by utilizing the user-computing device 102, via the transceiver 206. In an embodiment, the user input comprises one or more parameters, such as information pertaining to a target audience.

After the retrieval of the multimedia content, the processor 202, in conjunction with the speech processor 208 and the content processor 210, may be configured to extract the one or more features from the multimedia content.

Speech Rate Associated with the Multimedia Content

The speech processor 208 may be configured to utilize the one or more speech processing techniques known in the art for the determination of the speech rate associated with the multimedia content. Examples of the one or more speech processing techniques may include, but are not limited to, ASA technique, VAD technique, and phonetically motivated technique. In an exemplary scenario, the multimedia content, such as an educational video, may comprise audio content, such as a voice of an instructor explaining a concept in the educational video. The speech processor 208 may determine the speech rate associated with the audio content in the multimedia content. The speech rate may correspond to a count of words uttered per unit time by the instructor. The speech processor 208 may determine that for a time interval, such as “10:00 to 12:00,” in the multimedia content, the instructor utters “168 words” in one minute. Thus, the speech processor 208 may determine the speech rate as “168 words per minute.” Further, the speech processor 210 may be configured to determine the timestamps, such as “10:00 to 12:00,” associated with the time interval of the determined speech rate, such as “168 words per minute.”

In an embodiment, the multimedia content may have a variable speech rate (i.e., different speech rates for different time intervals in the multimedia content). For example, for a first time interval, such as “10:00 to 12:03,” the speech rate may be “168 words per minute.” Further, for a second time interval, such as “12:04 to 14:34,” the speech rate may be “182 words per minute.”

Timestamps Associated with the one or more Concepts in the Multimedia Content

The content processor 210 may be configured to determine the timestamps associated with the one or more concepts in the multimedia content. Prior to the determination of the timestamps, the content processor 210 may be configured to identify the one or more concepts associated with the multimedia content. For the identification of the one or more concepts, the content processor 210 may utilize the one or more topic detection algorithms known in the art. Examples of the one or more topic detection algorithms may include, but are not limited to, Event boundary detection algorithm and Gaussian mixture modelling. In an embodiment, the multimedia content may comprise textual content for describing the one or more concepts in the multimedia content. Further, the textual content may comprise one or more words displayed in a plurality of frames of the multimedia content. In an embodiment, the content processor 210 may utilize one or more aesthetic features associated with the textual content in the multimedia content to identify the one or more concepts in the multimedia content. Examples of the one or more aesthetic features may include bold, font size, font type, letter case, underline, and color of the word in the multimedia content. Further, the speech processor 208 may utilize one or more speech features, such as energy, pitch, and/or the like, associated with the audio content in the multimedia content to identify the one or more concepts in the multimedia content.

In an exemplary scenario, the multimedia content may correspond to an educational video. The educational video usually comprises one or more concepts. The content processor 210 may determine the one or more aesthetic features associated with the textual content (i.e., the one or more words) in the educational video. The content processor 210 may determine the font size of each of the one or more words in the textual content of the educational video. If a word in the one or more words has a font size greater than the other one or more words, the word may be of more importance than the other one or more words. Thus, the word may be associated with the start of a concept of the one or more concepts in the multimedia content. For example, the content processor 210 may determine the font size of the word “Newton's” to be “16pt.” The content processor 210 may further determine the font size of the word “First” to be “12pt.” Therefore, the word “Newton's” may be of more importance than the word “First” and may be associated with the start of a concept.

A person having ordinary skill in the art will understand that the abovementioned exemplary scenario is for illustrative purpose and should not be construed to limit the scope of the disclosure. Further, the content processor 210 may utilize any other topic detection technique known in the art for the determination of the one or more concepts in the multimedia content.

After the determination of the one or more concepts, the content processor 210 may be configured to determine the timestamps associated with the one or more concepts. In an embodiment, the content processor 210 may determine two timestamps (i.e., a start timestamp and an end timestamp) for each of the one or more concepts.

### Exemplary Instance in the Multimedia Content

In an embodiment, the content processor 210 may be configured to determine the requirement of the exemplary instance in the multimedia content. The content processor 210 may utilize the one or more techniques known in the art to determine the requirement of the exemplary instance associated with the multimedia content. Examples of the one or more exemplary instance determination techniques may include, but are not limited to, recognition of character by OCR technique, and recognition of speech by ASR technique. The exemplary instance may correspond to a detailed explanation required for the concept associated with the multimedia content. In an embodiment, the requirement of the occurrence of the exemplary instance may be determined based on the historical data that comprises information pertaining to the prior interaction of the one or more users with the multimedia content. In an exemplary scenario, while viewing the multimedia content of duration, such as “40 minutes,” the one or more users frequently use pause-play operation between a time interval, such as “20:00 to 30:00,” of the multimedia content. In this scenario, the requirement of the exemplary instance may be determined between the time interval (i.e., “20:00 to 30:00”) of the multimedia content based on the prior interaction (i.e., the usage of pause-play, navigation operation) of the one or more users with the multimedia content.

In another embodiment, the content processor 210 may determine the requirement of the exemplary instance based on the one or more parameters in the received user input, such as information pertaining to a target audience. In an exemplary scenario, based on the one or more parameters, the content processor 210 may determine that the user, who transmitted the input, teaches one or more students (i.e., the target audience) between an age group of “10 to 12 years.” Thus, the content processor 210 may determine the requirement of the exemplary instance, in the multimedia content, that is suitable for the age group of “10 to 12 years.”

In another embodiment, the content processor 210 may determine the requirement of the exemplary instance based on the user profile of the user. Prior to the determination of the requirement of the exemplary instance, the content processor 210 may retrieve the user profile of the user from the database server 106. Further, based on the user profile of the user the content processor 210 may determine that a preferred language of the user is “English.” Further, the speech processor 208, in conjunction with the content processor 210, may perform the audio and/or video analysis of the multimedia content. Based on the audio and/or video analysis, the speech processor 208 determines that between a time duration, such as “10:00 to 15:45,” the multimedia content comprises the audio content and/or the textual content in a language, such as “French,” different from the preferred language of the user. Thus, the speech processor 208 may determine the requirement of the exemplary instance, in the multimedia content for the time duration “10:00 to 15:45.”

A person having ordinary skill in the art will understand that the abovementioned exemplary scenarios are for illustrative purpose and should not be construed to limit the scope of the disclosure.

### The Style of Frames in the Multimedia Content

In an embodiment, the content processor 210 may be configured to determine the style of frames in the multimedia content. In an embodiment, the style of frames may comprise one or more production styles known in the art. Examples of the one or more production styles may include, but are not limited to, a “pdf” style, a “ppt” style, a classroom recording style, a digital tablet drawing style and/or a talking instructor head style. In an embodiment, the multimedia content may include the plurality of frames. Further, a frame of the plurality of frames may be associated with a production style of the one or more production styles. The content processor 210 may utilize the one or more techniques known in the art for the determination of the style of frames associated with the multimedia content. Examples of the one or more techniques utilized for the determination of the style of frames may include, but are not limited to, Event boundary detection technique and Pixel value detection technique.

For the determination of the style of frames associated with each of the plurality of frames in the multimedia content, the content processor 210 may determine pixel value of each of the plurality of frames in the multimedia content. Thereafter, the content processor 210 may determine a pixel difference among all consecutive frames in the plurality of frames in the multimedia content. In an embodiment, the pixel difference among all the consecutive frames may be obtained by performing a subtraction between the corresponding pixel values of each of the consecutive frames in the multimedia content. In an embodiment, if the pixel difference between any two consecutive frames of the multimedia content is below a first pre-specified threshold value, the two consecutive frames may be considered to have a same (or similar) production style, else the production style is considered to be different. For example, a first frame corresponds to a “pdf” style and a second frame corresponds to a “ppt” style. The content processor 210 may determine that the pixel difference between the pixel value first frame and the second frame is greater than the first pre-specified threshold value, thus the frames may correspond to the different production styles.

A person having ordinary skill in the art will understand that the scope of the abovementioned example is for illustrative purpose and should not be construed to limit the scope of the disclosure.

Occurrence of the one or more Graphical Items in the Multimedia Content

In an embodiment, the content processor 210 may be configured to determine the occurrence of the one or more graphical items in the multimedia content. The content processor 210 may utilize the one or more techniques known in the art for the determination of the occurrence of the one or more graphical items in the multimedia content. Examples of the one or more techniques to determine the occurrence of the one or more graphical items in the multimedia content may include, but are not limited to, Mean-Shift Segmentation technique and/or a Sobel operator technique. In an embodiment, the content processor 210 may utilize the determined pixel values for the determination of the occurrence of the one or more graphical items in the multimedia content.

In an exemplary scenario, the content processor 210 may determine a count of pixels in each frame of the plurality of frames of the multimedia content that has a pixel value less than a predefined pixel value. The predefined pixel value corresponds to a maximum intensity value associated with background of the plurality of frames of the multimedia content. Further, if the determined count of pixels in a frame of the plurality of frames is greater than a second pre-specified threshold, the frame may comprise the one or more graphical items. Further, the content processor 210 may determine the timestamp associated with the frame. The determined timestamp may correspond to the occurrence of the one or more graphical items in the multimedia content.

A person having ordinary skill in the art will understand that the abovementioned exemplary scenario is for illustrative purpose and should not be construed to limit the scope of the disclosure.

At step 306, the one or more multimedia segments are determined from the multimedia content based on the extracted one or more features associated from the multimedia content. In an embodiment, the content processor 210, in conjunction with the processor 202, may be configured to determine the one or more multimedia segments from the multimedia content. In an embodiment, each of the one or more multimedia segments may comprise one or more frames from the plurality of frames of the multimedia segment. In an embodiment, the extracted one or more features correspond to the requirement of the exemplary instance, the speech rate associated with the multimedia content, the style of frames in the multimedia content, timestamps associated with the one or more concepts in the multimedia content, and the occurrence of one or more graphical items in the multimedia content.

In an embodiment, the content processor 208 may determine the one or more multimedia segments based on an extracted feature (i.e., the speech rate determined from the audio content associated with the multimedia content) from the multimedia content. For example, for the determination of the one or more multimedia segments, the content processor 208 may utilize the determined timestamps, such as “00:00 to 10:17,” “10:18 to 20:45,” “20:46 to 34:30,” and “34:31 to 40:00,” for the determined speech rates, such as “145 words per minute,” “165 words per minute,” “181 words per minute,” and “145 words per minute,” respectively, in the multimedia content. Further, the content processor 208 may identify one or more frames from the plurality of frames in the multimedia content that are encompassed by each of the determined timestamps. Further, the one or more frames encompassed by each of the determined timestamps may correspond to a multimedia segment of the one or more multimedia segments. Thus, the content processor 210 may determine four multimedia segments from the multimedia content based on the extracted feature (i.e., the speech rate) associated with the multimedia content.

In another embodiment, the content processor 208 may determine the one or more multimedia segments based on another extracted feature (i.e., the timestamps associated with the one or more concepts in the multimedia content) from the multimedia content. For example, for the determination of the one or more multimedia segments, the content processor 208 may utilize the determined start timestamp and the determined end timestamp, such as “00:00 to 10:20,” “10:21 to 19:45,” “19:46 to 30:37,” and “30:38 to 40:00,” for each of the determined one or more concepts in the multimedia content of duration “40 minutes.” Based on the determined start timestamp and the determined end timestamp associated with each of the one or more concepts, the content processor 208 may identify one or more frames from the plurality of frames, in the multimedia content, that are encompassed by each of the determined start timestamp and the determined end timestamp. Further, the one or more frames encompassed by each of the determined timestamps (i.e., the start timestamp and the end timestamp) may correspond to a multimedia segment of the one or more multimedia segments. Thus, the content processor 210 may determine four multimedia segments from the multimedia content based on the extracted feature (i.e., the timestamps associated with the one or more concepts) with the multimedia content.

In another embodiment, the content processor 208 may determine the one or more multimedia segments based on another extracted feature (i.e., the requirement of the exemplary instance in the multimedia content) from the multimedia content. For example, for the determination of the one or more multimedia segments, the content processor 208 may utilize the determined timestamps, such as “10:21 to 19:45” and “30:46 to 40:00,” for the exemplary instance in the multimedia content. Based on the timestamps, the content processor 208 may identify one or more frames from the plurality of frames, in the multimedia content, that are encompassed by each of the determined timestamps. Further, the one or more frames encompassed by each of the determined timestamps may correspond to a multimedia segment of the one or more multimedia segments. Thus, the content processor 210 may determine two multimedia segments from the multimedia content based on the extracted feature (i.e., exemplary instance in the multimedia content) with the multimedia content.

In another embodiment, the content processor 208 may determine the one or more multimedia segments based on another extracted feature (i.e., the style of frames in the multimedia content) from the multimedia content. For example, based on the determined style of frames, the content processor 210 may identify consecutive frames from the plurality of frames that have same (or similar) production style. Further, the content processor 210 may determine timestamps, such as “00:00 to 09:17,” “09:18 to 22:48,” “22:49 to 22:50,” and “34:31 to 40:00,” associated with the consecutive frames of the determined style of frames, such as “pdf,” “pdf,” and “ppt,” respectively. Further, the consecutive frames associated with the determined timestamps, such as “00:00 to 09:17,” may correspond to a multimedia segment of the one or more multimedia segments. Thus, the content processor 208 may determine four multimedia segments from the multimedia content based on the extracted feature (i.e., the style of frames) associated with the multimedia content.

In another embodiment, the content processor 208 may determine the one or more multimedia segments based on another extracted feature (i.e., the occurrence of the one or more graphical items in the multimedia content) from the multimedia content. For example, for the determination of the one or more multimedia segments, the content processor 208 may utilize the determined timestamps, such as “10:54,” “10:55,” and “11:34,” associated with the occurrence of the one or more graphical items, such as “FIG. 1,” “FIG. 1,” and “FIG. 2,” in the multimedia content. Further, each of the determined timestamp may correspond to a multimedia segment of the one or more multimedia segments.

A person having ordinary skill in the art will understand that the abovementioned examples are for illustrative purpose and should not be construed to limit the scope of the disclosure.

At step 308, the set of multimedia segments is selected from the one or more multimedia segments in the multimedia content. In an embodiment, the set of multimedia segments is selected from the one or more multimedia segments based on the historical data and the one or more features associated with the one or more multimedia segments. In an embodiment, the content processor 210 may select the set of multimedia segments from the one or more multimedia segments based on a comparison between the one or more features associated with the one or more multimedia segments and the historical data of the multimedia content.

In an exemplary scenario, based on the historical data, the content processor 210 may determine that the one or more users performed the one or more operations, such as pause, play, stop, fast forward, navigation (to one or more websites) and/or the like, on the multimedia content when the speech rate of the multimedia content exceeds “172 words per minute.” Thereafter, the content processor 210 may determine “172 words per minute” as a speech rate threshold. Further, the content processor 210 may compare the speech rate of the one or more multimedia segments with the speech rate threshold. Further, based on the comparison, the multimedia segments in the one or more multimedia segments that have a speech rate greater than the speech rate threshold (i.e., “172 words per minute”) may correspond to a multimedia segment in the set of multimedia segments. Thus, the content processor 210 may select a multimedia segment associated with timestamps “20:46 to 34:30” with a speech rate of “181 words per minute.”

In another exemplary scenario, the one or more parameters in the user input may comprise the information pertaining to the target audience, such as a pre-specified threshold “172 words per minute” for the speech rate. Further, the content processor 210 may compare the speech rate of the one or more multimedia segments with the pre-specified threshold for the speech rate. Further, based on the comparison, the multimedia segments in the one or more multimedia segments that have a speech rate greater than the pre-specified threshold (i.e., “172 words per minute”) may correspond to a multimedia segment in the set of multimedia segments. Thus, the content processor 210 may select a multimedia segment associated with timestamps “20:46 to 34:30” with a speech rate of “181 words per minute.”

A person having ordinary skill in the art will understand that the scope of the disclosure is not limited to determine the speech rate threshold. In another embodiment, the speech rate may be a third pre-specified threshold.

In another exemplary scenario, the content processor 210 may select the multimedia segments in the one or more multimedia segment that are associated with the requirement of the exemplary instance and the occurrence of the one or more graphical items as the multimedia segments in the set of multimedia segments.

In another exemplary scenario, the content processor 210 may select a multimedia segment based on timestamps, such as “00:00 to 09:17” and “22:49 to 22:50,” from the one or more multimedia segments that is associated with a predefined style of frames, such as a “pdf” style. Thus, selected multimedia segments may correspond to the multimedia segments in the set of multimedia contents.

A person having ordinary skill in the art will understand that the abovementioned exemplary scenarios are for illustrative purpose and should not be construed to limit the scope of the disclosure.

At step 310, the set of multimedia segments in the multimedia content is recommended through the user interface displayed on the user-computing device 102 associated with the user. In an embodiment, the processor 202, in conjunction with the transceiver 206, may be configured to recommend the set of multimedia segments in the multimedia content through the user interface displayed on the user-computing device 102 associated with the user. In an embodiment, the user may utilize the user interface to annotate the recommended set of multimedia segments. In an embodiment, the annotation may correspond to insertion of the one or more of textual content, visual content, audio content, and/or an external link in the selected set of multimedia segments in the multimedia content.

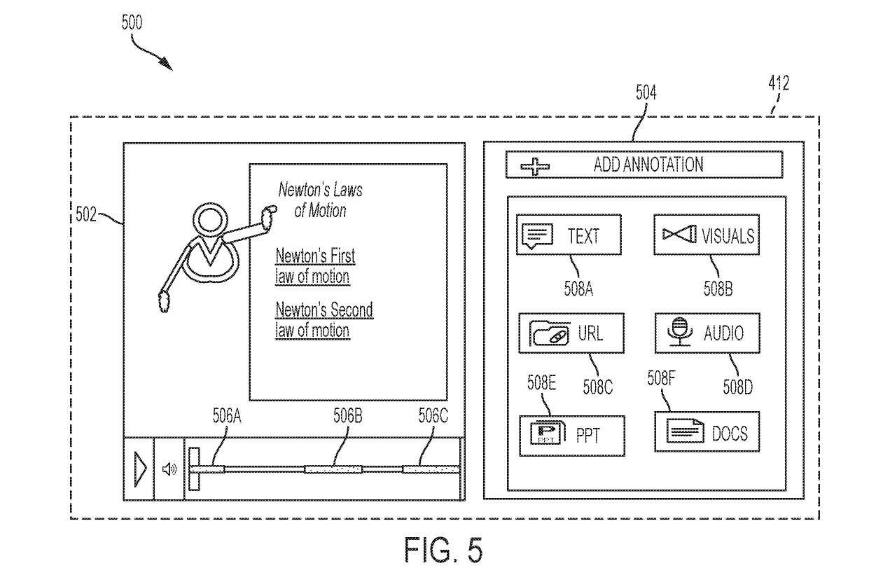

An exemplary user interface for recommending the set of multimedia content, for annotation, to the user has been described later in FIG. 5.

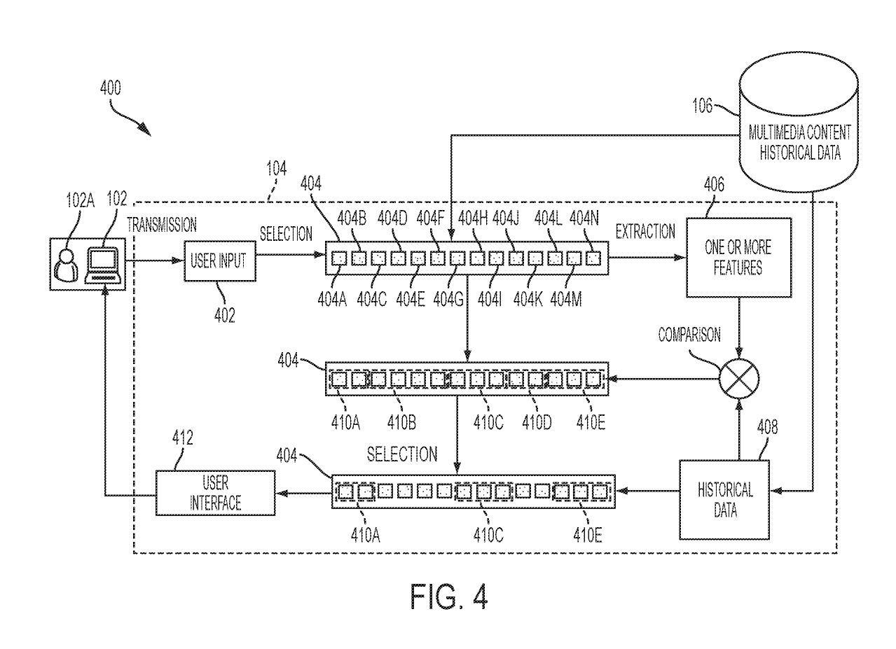

FIG. 4 is a block diagram that illustrates an exemplary scenario for recommending multimedia segments, in multimedia content, to a user for annotation, in accordance with at least one embodiment. FIG. 4 has been explained in conjunction with FIGS. 1-3. With reference to FIG. 4, there is shown an exemplary scenario 400 for recommending the set of multimedia segments, in the multimedia content, to the user for annotation.

The application server 104 may receive a user input 402 from the user-computing device 102 associated with a user 102a. Based on the received input, the application server 104 may select multimedia content 404. Thereafter, based on the selection, the application server 104 may query the database server 106 for the retrieval of the selected multimedia content 404. In an embodiment, the selected multimedia content 404 may comprise a plurality of frames, such as frames 404A-404N.

Thereafter, the application server 104 may extract the one or more features 406 from each of the plurality of frames, such as frames 404A-404N, of the multimedia content 404. In an embodiment, the one or more features 406 may comprise the requirement of the exemplary instance, the speech rate associated with the multimedia content 404, the timestamps associated with the one or more concepts in the multimedia content 404, the style of frames in the multimedia content 404, and the occurrence of one or more graphical items in the multimedia content 404.

Further, the application server 104 may determine the one or more multimedia segments, such as multimedia segments 410A-410E, of the multimedia content 404, based on the extracted one or more features 406 and historical data 408, retrieved from the database server 106. Thereafter, the application server 104 may select a set of multimedia segments, such as multimedia segments 410A, 410C, and 410E, from the one or more multimedia segments, such as the multimedia segments 410A-410E. The application server 104 may select the set of multimedia segments, such as multimedia segments 410A, 410C, and 410E, based on the historical data 408.

After the selection of the set of multimedia segments, such as multimedia segments 410A, 410C, and 410E, the application server 104 may recommend the set of multimedia segments to the user-computing device 102 through a user interface 412. The user 102A associated with the user-computing device 102 may utilize the user interface 412 for annotating the multimedia content 404.

FIG. 5 is a block diagram that illustrates an exemplary Graphical User-Interface (GUI) presented on a user-computing device to display recommended multimedia segments in multimedia content for annotation, in accordance with at least one embodiment. FIG. 5 has been explained in conjunction with FIGS. 1-4. With reference to FIG. 5, there is shown an exemplary scenario 500 for presenting a GUI 412 on the user-computing device 102 to display the recommended set of multimedia segments in the multimedia content for annotation.

The GUI 412 may be displayed on a display screen of the user-computing device 102 associated with the user 102A. Further, the GUI 412 may comprise two sections, such as a first display area 502 and a second display area 504. The first display area 502 displays the multimedia content to the user. In an embodiment, the first display area 502 may contain command buttons such as, play, rewind, forward, and pause, to control playback of the multimedia content. In an embodiment, a navigation bar may be displayed on the first display area 502 that enables the user to navigate through the multimedia content. Further, the navigation bar may comprise the recommended set of multimedia segments, such as the multimedia segments 506A, 506B, and 506C. In an embodiment, when the user clicks on any of the recommended set of multimedia segments, such as the multimedia segments 506A, 506B, and 506C, the second display area 504 may be displayed to the user. Further, the second display area 504 may comprise one or more annotation options, such as options 508A-508F. The user may click on the one or more annotation options, such as options 508A-508F, to select a mode of annotating the multimedia segment in the recommended set of multimedia segments. For example, the user may click on the multimedia segment 506A on the navigation bar in the first display area 502. Thereafter, the user may select an annotation option 508A, from the one or more annotation options, to annotate the multimedia segment 506A with textual content.

The disclosed embodiments encompass numerous advantages. The disclosure provides a method and a system for recommending multimedia segments in multimedia content associated with online educational courses for annotation via a user interface. The disclosed method and system utilize historical data for selecting a set of multimedia segments, for annotation, in the multimedia content. The historical data comprises information pertaining to a prior interaction of one or more users with the multimedia content. The disclosed method and system further utilize one or more features extracted from the multimedia content for the selection of the set of multimedia segments. The extracted one or more features may comprise at least a requirement of an exemplary instance, speech rate associated with the multimedia content, a style of frames in the multimedia content, timestamps associated with one or more concepts in the multimedia content, and an occurrence of one or more graphical items in the multimedia content. The disclosed method and system provide a robust and fast method of determining the set of multimedia segments, in the multimedia content, which requires annotation for enhancing the interest of the one or more users in the multimedia content. The disclosed method and system may be utilized by an education provider that uses multimedia content as a mode of education.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or similar devices that enable the computer system to connect to databases and networks such as LAN, MAN, WAN, and the internet. The computer system facilitates input from a user through input devices accessible to the system through the I/O interface.

In order to process input data, the computer system executes a set of instructions that are stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks such as steps that constitute the method of the disclosure. The systems and methods described can also be implemented using only software programming, only hardware, or a varying combination of the two techniques. The disclosure is independent of the programming language and the operating system used in the computers. The instructions for the disclosure can be written in all programming languages including, but not limited to, “C,” “C++,” “Visual C++,” and “Visual Basic.” Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, “Unix,” “DOS,” “Android,” “Symbian,” and “Linux.”

The programmable instructions can be stored and transmitted on a computer-readable medium. The disclosure can also be embodied in a computer program product comprising a computer-readable medium, with any product capable of implementing the above methods and systems, or the numerous possible variations thereof.

Various embodiments of the methods and systems for recommending multimedia segments in multimedia content associated with online educational courses for annotation via a user interface have been disclosed. However, it should be apparent to those skilled in the art that modifications, in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, used, or combined with other elements, components, or steps that are not expressly referenced.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A method for recommending multimedia segments in multimedia content associated with online educational courses for annotation via a user interface, the method comprising:
extracting, by one or more processors, one or more features associated with the multimedia content, wherein the multimedia content is selected based on a user input received from a user-computing device, wherein a feature of the one or more features corresponds to at least a requirement of an exemplary instance;
selecting, by the one or more processors, a set of multimedia segments from one or more multimedia segments in the multimedia content, based on historical data that corresponds to interaction of one or more users with the multimedia content and the extracted one or more features associated with the multimedia content; and
recommending, by the one or more processors, the selected set of multimedia segments in the multimedia content through the user interface displayed on the user-computing device associated with a user, wherein the user annotates the recommended set of multimedia segments in the multimedia content.

2. The method of claim 1, wherein the one or more features further comprise speech rate associated with the multimedia content, a style of frames in the multimedia content, timestamps associated with one or more concepts in the multimedia content, and an occurrence of one or more graphical items in the multimedia content.

3. The method of claim 2, wherein the occurrence of the one or more graphical items in the multimedia content is determined based on at least a Mean-Shift Segmentation technique.

4. The method of claim 1, further comprising comparing, by the one or more processors, at least one feature of the extracted one or more features with a pre-specified threshold value.

5. The method of claim 1, wherein the selection of the set of multimedia segments is further based on the comparison.

6. The method of claim 1, wherein a multimedia segment of the selected set of multimedia segments corresponds to a time interval between two timestamps in the multimedia content.

7. The method of claim 1, wherein the annotation corresponds to insertion of one or more of textual content, visual content, audio content, and an external link in the selected set of multimedia segments in the multimedia content.

8. The method of claim 1, wherein the selection of the set of multimedia segments from the one or more multimedia segments in the multimedia content is based on one or more parameters in the user input, wherein the one or more parameters comprise at least information pertaining to a target audience.

9. The method of claim 1, further comprising determining the one or more multimedia segments in the multimedia content based on the extracted one or more features associated with the multimedia content.

10. The method of claim 1, wherein the requirement of the exemplary instance is determined based on audio and/or video analysis of the multimedia content.

11. A system for recommending multimedia segments in multimedia content associated with online educational courses for annotation via a user interface, the system comprising:
one or more processors configured to:
extract one or more features associated with the multimedia content, wherein the multimedia content is selected based on a user input received from a user-computing device, wherein a feature of the one or more features corresponds to at least a requirement of an exemplary instance;
select a set of multimedia segments from one or more multimedia segments in the multimedia content, based on historical data that corresponds to interaction of one or more users with the multimedia content and the extracted one or more features associated with the multimedia content; and
recommend the selected set of multimedia segments in the multimedia content through the user interface displayed on the user-computing device associated with a user, wherein the user annotates the recommended set of multimedia segments in the multimedia content.

12. The system of claim 11, wherein the one or more features further comprise speech rate associated with the multimedia content, a style of frames in the multimedia content, timestamps associated with one or more concepts in the multimedia content, and an occurrence of one or more graphical items in the multimedia content.

13. The system of claim 12, wherein the occurrence of the one or more graphical items in the multimedia content is determined based on at least a Mean-Shift Segmentation technique.

14. The system of claim 11, wherein the one or more processors are further configured to compare, by the one or more processors, at least one feature of the extracted one or more features with a pre-specified threshold value.

15. The system of claim 11, wherein the selection of the set of multimedia segments is further based on the comparison.

16. The system of claim 11, wherein a multimedia segment of the selected set of multimedia segments corresponds to a time interval between two timestamps in the multimedia content.

17. The system of claim 11, wherein the annotation corresponds to insertion of one or more of textual content, visual content, audio content, and an external link in the selected set of multimedia segments in the multimedia content.

18. The system of claim 11, wherein the one or more processors are further configured to determine, the one or more multimedia segments in the multimedia content based on the extracted one or more features associated with the multimedia content.

19. The system of claim 11, wherein the selection of the set of multimedia segments from the one or more multimedia segments in the multimedia content is based on one or more parameters in the user input, wherein the one or more parameters comprise at least information pertaining to a target audience.

20. A computer program product for use with a computer, the computer program product comprising a non-transitory computer readable medium, wherein the non-transitory computer readable medium stores a computer program code for recommending multimedia segments in multimedia content associated with online educational courses for annotation via a user interface, wherein the computer program code is executable by one or more processors to:
extract one or more features associated with the multimedia content, wherein the multimedia content is selected based on a user input received from a user-computing device, wherein a feature of the one or more features corresponds to at least a requirement of an exemplary instance;
select a set of multimedia segments from one or more multimedia segments in the multimedia content, based on historical data that corresponds to interaction of one or more users with the multimedia content and the extracted one or more features associated with the multimedia content; and
recommend the selected set of multimedia segments in the multimedia content through the user interface displayed on the user-computing device associated with a user, wherein the user annotates the recommended set of multimedia segments in the multimedia content.
